(19) United States
(12) Patent Application Publication
(10) Pub. No.: US 2022/0189307 A1
(43) Pub. Date: Jun. 16, 2022

(54) PRESENTATION OF DYNAMIC THREAT INFORMATION BASED ON THREAT AND TRAJECTORY PREDICTION

(71) Applicant: GM GLOBAL TECHNOLOGY OPERATIONS LLC, Detroit, MI (US)

(72) Inventors: Yael Shmueli Friedland, Tel Aviv (IL); Claudia V. Goldman-Shenhar, Mevasseret Zion (IL); Asaf Degani, Raanana (IL); Lisa M. Talarico, Milford, MI (US); Ron M. Hecht, Raanana (IL)

(21) Appl. No.: 17/123,682

(22) Filed: Dec. 16, 2020

(51) Int. Cl. G08G 1/16

(52) U.S. Cl. CPC G08G 1/16

(57) ABSTRACT

A system for notifying a user of a vehicle includes a receiving module configured to receive detection data, and a threat analysis module configured to receive object detection data related to a detected object in an environment around the vehicle, acquiring a predicted trajectory of the detected object, and determine whether the detected object constitutes a threat based on the predicted trajectory of the detected object and a vehicle trajectory. The system also includes a threat display module configured to determine an operating scenario based on a user attentiveness, a field of view, an operating mode, and a threat level, and generate a notification to the user representing the threat, the notification including a visual representation of the detected object and a visual indicator of the predicted trajectory of the detected object. At least one of the visual representation and the visual indicator is customized based on the operating scenario.

### INTRODUCTION

The subject disclosure relates to the art of presenting detected threats and their trajectory, and detection and mitigation. More particularly, the subject disclosure relates to a system and method for predicting or assessing threat conditions and generating user alerts.

Threat detection is an important aspect of many modern vehicles, and finds utility in both manual vehicles and vehicles having autonomous and semi-autonomous capability. Cameras and/or other imaging devices and sensors are increasingly included in vehicles to facilitate vehicle operation and allow for detection of potential threats. Effective threat detection and notification of potential threats can be a challenge, particularly in dynamic situations in which potential threats are moving and/or in situations in which a driver or user is in a distracted state

### SUMMARY

In one exemplary embodiment, a system for notifying a user of a vehicle includes a receiving module configured to receive detection data from one or more sensors, and a threat analysis module configured to receive object detection data related to a detected object in an environment around the vehicle, acquiring a predicted trajectory of the detected object, and determine whether the detected object constitutes a threat based on the predicted trajectory of the detected object and a vehicle trajectory. The system also includes a threat display module configured to, based on determining that the object constitutes a threat, determine an operating scenario based on a user attentiveness, a field of view , an operating mode, and a threat level, and generate a notification to the user representing the threat, the notification including a visual representation of the detected object and a visual indicator of the predicted trajectory of the detected object. At least one of the visual representation and the visual indicator is customized based on the operating scenario.

In addition to one or more of the features described herein, the operating mode is selected from a manual operating mode, a partially autonomous operating mode and a fully autonomous operating mode.

In addition to one or more of the features described herein, the operating scenario includes a threat structure selected from a discrete threat and a combined threat.

In addition to one or more of the features described herein, the notification includes a visual representation of a dependency between multiple objects representing the combined threat.

In addition to one or more of the features described herein, the threat display module is configured to incorporate at least one of an auditory alert and a haptic alert into the notification based on determining that a threat level is above a selected value, and/or based on determining that the user is inattentive relative to the detected object.

In addition to one or more of the features described herein, a property of at least one of the visual representation of the detected object, the visual indicator of the predicted trajectory, the auditory alert and the haptic alert is gradually altered in real time as the threat level changes.

In addition to one or more of the features described herein, the property of at least one of the visual representation and the visual indicator is selected from at least one of a color, an opacity, a brightness, a blink rate, a texture and an intensity.

In addition to one or more of the features described herein, the notification includes an adjustment of interior lighting in the vehicle based on at least one of the threat levels and the user attentiveness.

In one exemplary embodiment, a method of notifying a user of a vehicle includes receiving detection data from one or more sensors, receiving object detection data related to a detected object in an environment around the vehicle based on the detection data, acquiring a predicted trajectory of the detected object, and determining whether the detected object constitutes a threat based on the predicted trajectory of the detected object and a vehicle trajectory. The method also includes, based on determining that the detected object constitutes a threat, determining an operating scenario based on a user attentiveness, a field of view, an operating mode, and a threat level, and generating a notification to the user representing the threat, the notification including a visual representation of the detected object and a visual indicator of the predicted trajectory of the detected object. At least one of the visual representation and the visual indicator is customized based on the operating scenario.

In addition to one or more of the features described herein, the operating mode is selected from a manual operating mode, a partially autonomous operating mode and a fully autonomous operating mode.

In addition to one or more of the features described herein, the operating scenario includes a threat structure selected from a discrete threat and a combined threat.

In addition to one or more of the features described herein, the notification includes a visual representation of a dependency between multiple objects representing the combined threat.

In addition to one or more of the features described herein, a threat display module is configured to incorporate at least one of an auditory alert and a haptic alert into the notification based on determining that a threat level is above a selected value, and/or based on determining that the user is inattentive relative to the detected object.

In addition to one or more of the features described herein, a property of at least one of the visual representation of the detected object, the visual indicator of the predicted trajectory, the auditory alert and the haptic alert is gradually altered in real time as the threat level changes.

In addition to one or more of the features described herein, the property of at least one of the visual representation and the visual indicator is selected from at least one of a color, an opacity, a brightness, a blink rate, a texture and an intensity.

In addition to one or more of the features described herein, the notification includes an adjustment of interior lighting in the vehicle based on at least one of the threat level and the user attentiveness.

In one exemplary embodiment, a vehicle system includes a memory having computer readable instructions, and a processing device for executing the computer readable instructions. The computer readable instructions control the processing device to perform receiving detection data from one or more sensors, receiving object detection data related to a detected object in an environment around the vehicle based on the detection data, acquiring a predicted trajectory of the detected object, and determining whether the detected object constitutes a threat based on the predicted trajectory of the detected object and a vehicle trajectory. The instructions also control the processing device to perform, based on determining that the detected object constitutes a threat, determining an operating scenario based on a user attentiveness, a field of view, an operating mode, and a threat level, and generating a notification to the user representing the threat, the notification including a visual representation of the detected object and a visual indicator of the predicted trajectory of the detected object. At least one of the visual representation and the visual indicator is customized based on the operating scenario.

In addition to one or more of the features described herein, a threat display module is configured to incorporate at least one of an auditory alert and a haptic alert into the notification based on determining that a threat level is above a selected value, and/or based on determining that the user is inattentive relative to the detected object.

In addition to one or more of the features described herein, a property of at least one of the visual representation of the detected object, the visual indicator of the predicted trajectory, the auditory alert and the haptic alert is gradually altered in real time as the threat level changes.

In addition to one or more of the features described herein, the notification includes an adjustment of interior lighting in the vehicle based on at least one of the threat level and the user attentiveness.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including aspects of a threat detection and notification system, in accordance with an exemplary embodiment;

FIG. 2 depicts a computer system configured to perform aspects of threat detection and notification, in accordance with an exemplary embodiment;

FIG. 3 is a flow chart depicting aspects of a method of detecting threats and presenting notifications, the method including determining a driving scenario, generating a prediction of an object trajectory, and designing and presenting a notification, in accordance with an exemplary embodiment;

FIG. 4 depicts aspects of a method of determining a driving scenario, in accordance with an exemplary embodiment;

FIGS. 5A and 5B depict aspects of a method of designing a notification, which includes selection of one or more display modalities, in accordance with an exemplary embodiment;

FIG. 6 depicts an example of the method of FIG. 5, which includes selection of one or more modalities as a function of threat level, in accordance with an exemplary embodiment;

FIG. 7 depicts aspects of a method of designing a user notification for a cluster display, in accordance with an exemplary embodiment;

FIG. 8 depicts aspects of a method of designing a user notification for an augmented reality display, in accordance with an exemplary embodiment;

FIG. 9 depicts an example of a user notification generated on a cluster display, the user notification representing an object identified as having a high threat level, and a predicted object trajectory, in accordance with an exemplary embodiment;

FIG. 10 depicts an example of a user notification generated on a cluster display, the user notification representing an object identified as having a medium threat level, and a predicted object trajectory, in accordance with an exemplary embodiment;

FIG. 11 depicts an example of a user notification generated on a cluster display, the user notification representing a child, a ball (identified as a threat), and a predicted trajectory of the ball, in accordance with an exemplary embodiment;

FIG. 12 depicts an example of a user notification generated on a cluster display, the user notification representing multiple road users (vehicles) identified as threats, in accordance with an exemplary embodiment;

FIG. 13 depicts an example of a user notification generated on a cluster display of an object identified as a threat with its predicted trajectory, during an autonomous operating mode, in accordance with an exemplary embodiment; and

FIG. 14 depicts an example of a user notification generated on an augmented reality heads up display of an object identified as a threat with its predicted trajectory, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods and systems are provided for monitoring an environment around a vehicle (or other machine, device or system for which threat or object detection is desirable), detecting potential threats and presenting contextual notifications to a user (e.g., driver or passenger) of the vehicle. An embodiment of a system is configured to acquire detection data from one or more vehicle sensors, and data relating to vehicle dynamics (e.g., speed, direction), and identify one or more potential threats represented by detected objects. The system acquires or determines a predicted trajectory of a detected object, and generates a notification to the user that accounts for user attentiveness and threat level to provide the user information about predictive dynamics of a threat (or combined threat), provide relevant context, and direct the user's attention. As discussed further below, the notification is customized based on threat level and attentiveness to provide a level of detail and sufficient stimulus to the user, to ensure that the user is alerted to a threat and has sufficient context to react.

The system, in one embodiment, acquires data related to a user condition, such as driver awareness and attention (e.g., is the user focused on the road, is the user looking toward the threat, is the user distracted, etc.) using a driver monitoring system (DMS) or other suitable sensing device or system. Environmental data may also be acquired, indicative of the vehicle environment and driving context (e.g., road layout, weather, traffic, etc.). Based on the above information, the system estimates a threat structure (a single threat or combined threat) and a threat level associated with a detected object or objects, and generates a notification using one or more available modalities that is contextualized based on the threat level and user attention level.

The notification utilizes one or more of various modalities, including a visual modality (graphics, text, etc.), an auditory modality (e.g., a beep, tone, or series thereof) and a haptic modality (e.g., steering wheel and/or seat vibration). The haptic and auditory modalities may be configured as directional signals to prompt the user to direct attention to a location of a threat. In one embodiment, the modalities include the use of interior lighting to alert the user. The combination and/or features of each modality are used to generate a notification that enhances user awareness of a given context without overly distracting the user.

Embodiments described herein present a number of advantages. The system provides benefits including enhanced situational awareness, both in providing relevant information to the user in an intuitive manner and effectively and promptly conveying the seriousness of a detected threat and its predicted trajectory. The system thus improves user response time and enhances accident avoidance, as compared to conventional systems.

Embodiments are described below in the context of vehicle operation. The embodiments are not so limited, and may be used in any of various contexts where situational awareness of a user is a factor. Thus, embodiments described herein are understood to be applicable to any of various contexts (e.g., operation of power tools, aircraft, construction activities, factory machines (e.g., robots) and others).

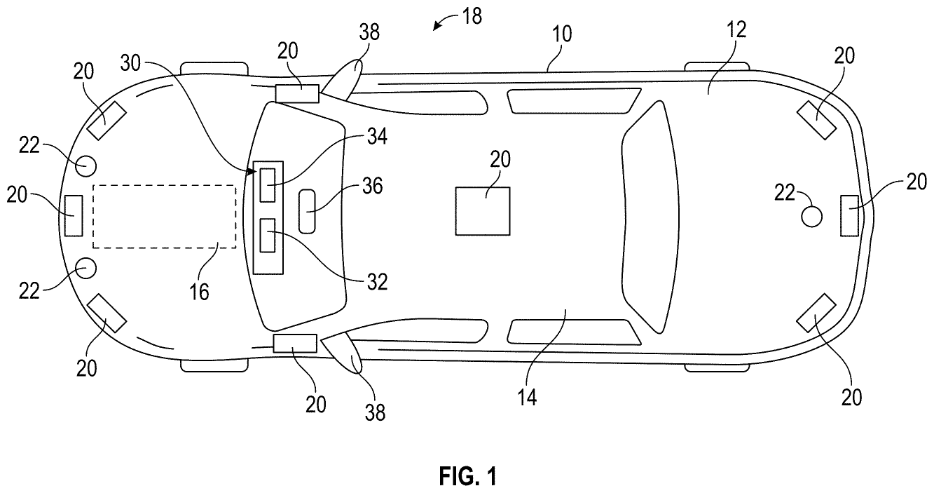

FIG. 1 shows an embodiment of a motor vehicle 10, which includes a vehicle body 12 defining, at least in part, an occupant compartment 14. The vehicle body 12 also supports various vehicle subsystems including an engine system 16 (e.g., combustion, electrical, and other), and other subsystems to support functions of the engine system 16 and other vehicle components, such as a braking subsystem, a steering subsystem, and others.

The vehicle also includes a threat detection and notification system 18, aspects of which may be incorporated in or connected to the vehicle 10. The system 18 in this embodiment includes one or more optical cameras 20 configured to take images, which may be still images and/or video images. Additional devices or sensors may be included in the system 18, such as one or more radar assemblies 22 included in the vehicle 10. The system 18 is not so limited and may include other types of sensors, such as infrared.

The vehicle 10 and the system 18 also include an on-board computer system 30 that includes one or more processing devices 32 and a user interface 34. The user interface 34 may include a touchscreen, a speech recognition system and/or various buttons for allowing a user to interact with features of the vehicle. The user interface 24 may be configured to interact with the user via visual communications (e.g., text and/or graphical displays), tactile communications or alerts (e.g., vibration), and/or audible communications. The on-board computer system 30 may also include or communicate with devices for monitoring the user, such as interior cameras and image analysis components. Such devices may be incorporated into a driver monitoring system (DMS).

In addition to the user interface, the vehicle 10 may include other types of displays and/or other devices that can interact with and/or impart information to a user. For example, in addition to, or alternatively, the vehicle 10 may include a display screen (e.g., a full display mirror or FDM) incorporated into a rearview mirror 36 and/or one or more side mirrors 38. In one embodiment, the vehicle 10 includes one or more heads up displays (HUDs). Other devices that may be incorporated include indicator lights, haptic devices, interior lights, auditory communication devices, and others. Haptic devices (tactile interfaces) include, for example, vibrating devices in the vehicle steering wheel and/or seat.

The various displays, haptic devices, lights, and auditory devices are configured to be used in various combinations to present information to a user (e.g., a driver, operator or passenger) in various forms. Examples of such forms include textual, graphical, video, audio, haptic and/or other forms by which information is communicated to the user. These forms of communication are combined and/or customized based on context in order to ensure that the user is promptly made aware of any detected threats, as discussed herein.

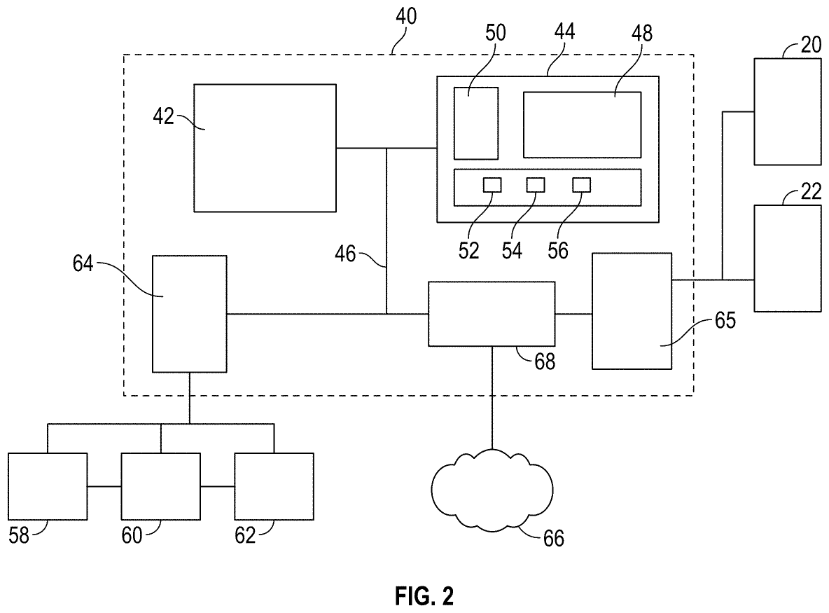

FIG. 2 illustrates aspects of an embodiment of a computer system 40 that is in communication with, or is part of, the threat detection and notification system 18, and that can perform various aspects of embodiments described herein. The computer system 40 includes at least one processing device 42, which generally includes one or more processors for performing aspects of image acquisition and analysis methods described herein. The processing device 42 can be integrated into the vehicle 10, for example, as the on-board processing device 32, or can be a processing device separate from the vehicle 10, such as a server, a personal computer or a mobile device (e.g., a smartphone or tablet).

Components of the computer system 40 include the processing device 42 (such as one or more processors or processing units), a system memory 44, and a bus 46 that couples various system components including the system memory 44 to the processing device 32. The system memory 44 may include a variety of computer system readable media. Such media can be any available media that is accessible by the processing device 42, and includes both volatile and non-volatile media, and removable and non-removable media.

For example, the system memory 44 includes a non-volatile memory 48 such as a hard drive, and may also include a volatile memory 50, such as random access memory (RAM) and/or cache memory. The computer system 40 can further include other removable/non-removable, volatile/non-volatile computer system storage media.

The system memory 44 can include at least one program product having a set (e.g., at least one) of program modules that are configured to carry out functions of the embodiments described herein. For example, the system memory 44 stores various program modules that generally carry out the functions and/or methodologies of embodiments described herein. A receiving module 52 may be included to perform functions related to acquiring and processing received images and information from detection devices, a threat analysis module 54 for analysis of detected images and threat estimation, and a threat display module 56 for displaying information to a user based on the detected threats. The system 40 is not so limited, as other modules may be included. The system memory 44 may also store various data structures, such as data files or other structures that store data related to imaging and image processing. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 42 can also communicate with one or more external devices 58 such as a keyboard, a pointing device, and/or any devices (e.g., network card, modem, etc.) that enable the processing device 42 to communicate with one or more other computing devices. In addition, the processing device 32 can communicate with one or more devices such as the cameras 20 and the radar assemblies 22 used for image analysis. The processing device 32 can communicate with one or more display devices 60 (e.g., an onboard touchscreen, cluster, center stack, HUD, mirror displays (FDM) and others), and vehicle control devices or systems 62 (e.g., for partially autonomous (e.g., driver assist) and/or fully autonomous vehicle control). Communication with various devices can occur via Input/Output (I/O) interfaces 64 and 65.

The processing device 32 may also communicate with one or more networks 66 such as a local area network (LAN), a general wide area network (WAN), and/or a public network (e.g., the Internet) via a network adapter 68. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

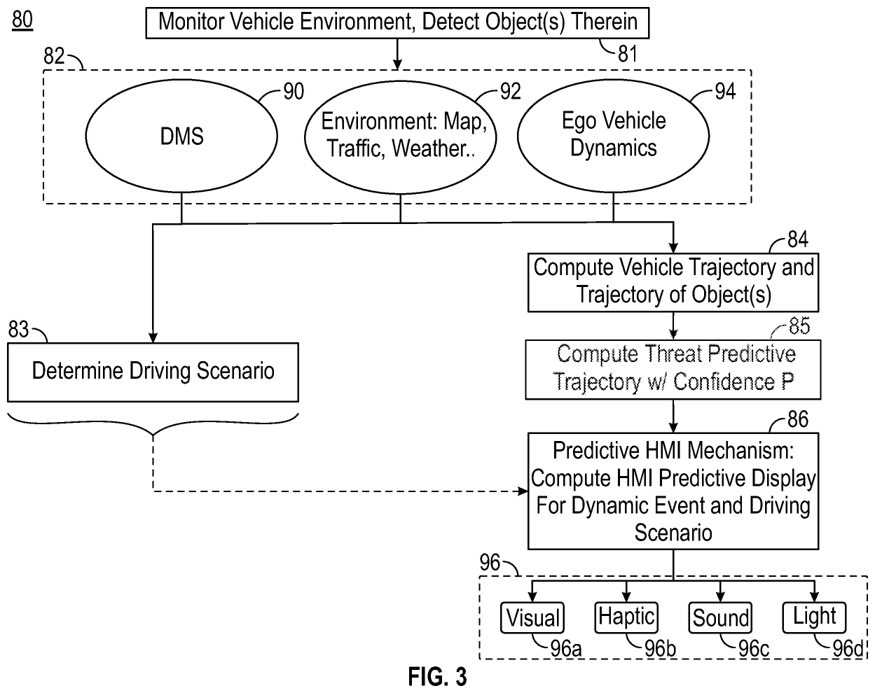

FIG. 3 depicts an embodiment of a method 80 of monitoring a vehicle environment and presenting a threat notification and the threat's predictive trajectory to a user. The system 18, or other processing device or system, may be utilized for performing aspects of the method 80. The method 80 is discussed in conjunction with blocks 81-86. The method 80 is not limited to the number or order of steps therein, as some steps represented by blocks 81-86 may be performed in a different order than that described below, or fewer than all of the steps may be performed.

It is noted that the method 80 and methods subsequently discussed are described as performed by a processing device, such as processor(s) in the vehicle 10 and/or the computer system 40. However, the methods may be performed by any suitable processing device or system. In addition, the methods may apply to various vehicle conditions, capabilities, environments. In one embodiment, the method is performed during driving conditions in which reaction time and threat detection are considered to be a priority (e.g., vehicle is moving at a threshold speed such as 8 mph).

The methods discussed herein are described in conjunction with the vehicle 10, but are not so limited and can be used in conjunction with various vehicles (e.g., cars, trucks, aircraft) and/or other systems (e.g., construction equipment, manufacturing systems, robotics, etc.).

At block 81, the processing device monitors vehicle surroundings or the vehicle environment using one or more of various monitoring devices during operation of a vehicle. For example, the processing device can monitor the environment around the vehicle using optical cameras and image analysis, and/or using radar. The vehicle 10 is considered an observer and may be referred to as an “ego vehicle.”

The processing device detects whether there are any objects in the environment, or acquires or receives data related to detected objects (e.g., from another processing device or system), and determines whether any detected objects are a threat. An object is considered a threat if the object is located at a predicted path of the vehicle 10, at a location that is within a selected distance, is moving in a direction that could interfere with or collide with the vehicle, or is otherwise in a position that could cause interference.

At block 82, the processing device collects data related to or indicative of the state of the driver (“user detection data”), data related to an environment around the vehicle (“environment data”), and data related to dynamics of the vehicle (“vehicle dynamics data”). The vehicle collects user data 90 via a driver monitoring system (DMS). Generally, the user data is utilized to determine a condition of the user related to a user's attentiveness. In one embodiment, a user is considered “attentive” if the user data 90 (e.g., eye tracking data) indicates that the user's attention is directed toward a detected object or a location or region affected by the threat, is looking at the road, or is otherwise in a condition in which the user is paying attention. A user is considered “inattentive” if the user's gaze is away from the road or a detected object or region, or if the user's condition is distracted.

In addition, the processing device collects environmental data 92, related to conditions or contexts of an environment in which the vehicle is located and/or operating. Environmental data 92 includes, for example, road layout, surrounding features and structures, map data, traffic information, weather data, road type data, traffic light data and others.

The processing device also collects vehicle dynamics data 94, such as speed and direction. The vehicle 10 is referred to subsequently herein as the “ego vehicle.”

At block 83, an operating or driving scenario is determined based on one or more of the following factors. The factors include user (e.g., driver) attentiveness, field of view (FOV), operating mode (e.g., manual, autonomous), display type, threat level and threat structure. The driving scenario may include all of the above factors (i.e., attentiveness, FOV, operating mode, display type, threat level and threat structure), or may include a subset of the above factors.

User or driver attentiveness relates to an assessment of whether a user's attention is directed toward a detected object or a region or area in which a detected object is located or expected to be located. User attentiveness, in one embodiment, is determined as being “attentive” if user data (e.g., from a DMS) indicates that the user is paying attention to a given object or region. Attentiveness may be determined based on eye tracking to determine the direction of the user's gaze. A user may be assessed as attentive or inattentive based on other indications, such as the user's emotional state (determined, e.g., by facial image analysis), and user behavior.

The FOV of the user is compared to the location of detected objects to determine whether the object is visible to the user. The notification generated as discussed below can be customized based on whether the object is in the user's field of view, or outside the FOV.

The operating scenario may include the type of display or display capabilities available in the ego vehicle. Examples of display types include cluster displays (e.g., digital instrument panel and graphics), heads up displays (HUD), mirror displays, augmented reality displays and others.

The threat level is indicative of the urgency of a detected threat. The threat level may be represented by a numerical score or discrete levels, such as high, medium and low. The threat level may be determined based on considerations such as ego vehicle speed, ego vehicle trajectory, distance between the ego vehicle and a detected object and their predictive trajectories, estimated time to collision, and/or any other consideration that can have an impact on the urgency of the threat and required reaction time.

The threat structure includes a discrete threat and a combined threat. A discrete threat refers to a single detected object representing the threat, and a combined threat refers to threat that includes multiple objects. A combined threat may include both the objects and their actual and predicted interdependencies. An example of a combined threat is a situation in which several cars ahead of the ego vehicle are braking.

At block 84, the trajectory of each detected object (i.e., object considered to be a threat or a potential threat) is acquired, or is calculated based on sensor data. In addition, the ego vehicle object trajectory may be acquired or calculated. For example, radar detections of an object or the ego vehicle can be plotted to estimate a trajectory of the object or ego vehicle.

At block 85, a predicted trajectory of each detected object and the ego vehicle is acquired or calculated. Detection data such as location, speed, the calculated trajectory is used to predict the trajectory. Based on the predicted trajectories, the processing device can determine when and where an object trajectory and the ego vehicle will intersect or come within a threshold distance of one another in a given prediction time frame (assuming the ego vehicle maintains its current speed and direction). Each predicted trajectory, and the prediction as to intersection, may be assigned a confidence score or level of confidence P.

At block 86, the operating scenario, current object and ego vehicle locations and trajectories, and the predicted trajectories are used to generate a user notification based on the threat, its trajectory, and the specific context of the threat. For example, the user notification includes a visual or graphical display in which detected objects, their trajectories, and an indication of a predicted collision point or affected area are visually depicted. Based on the threat level and threat condition, visual representations are included in the display with features designed to notify a user of a threat and ensure that the user attention is directed to the threat and to the threat's predictive trajectory. For example, object and/or trajectory representations may be color-coded, shaded, intensified or otherwise emphasized to give the user a quick and intuitive impression of the threat. In one embodiment, the intensity of representations may vary gradually as the threat level increases (e.g., the ego vehicle moves closer to a detected object).

In addition, the type and/or intensity of the notification are dependent on the level of the threat and whether there is a combined threat. For example, if a combined threat is determined, the notification may provide additional detail regarding dependencies between detected objects or threats.

The notification may include one or more modalities, including a visual modality, an auditory modality and/or a haptic modality. The type and combination of modality may be dependent on the operating scenario, threat level and/or threat structure. For example, lower level threats may result in a notification having a single modality, such as a visual display. For higher level threats (or if the threat level increases) additional modalities (auditory and/or haptic) may be added to increase the sense of urgency conveyed to the user.

For example, the processing device generates a notification 96, which may include any combination of a visual display 96a, a haptic signal 96b, an audio (e.g., tonal or verbal) alert 96c and a lighting signal 96d.

For example, the notification is provided by different modalities, including visual (e.g., including panning and zooming in and out as required), directional sound/haptics (isolated or combined) and spoken alerts, depending on the estimated reaction time of the driver. Interior lighting can be also manipulated to focus the user attention when needed.

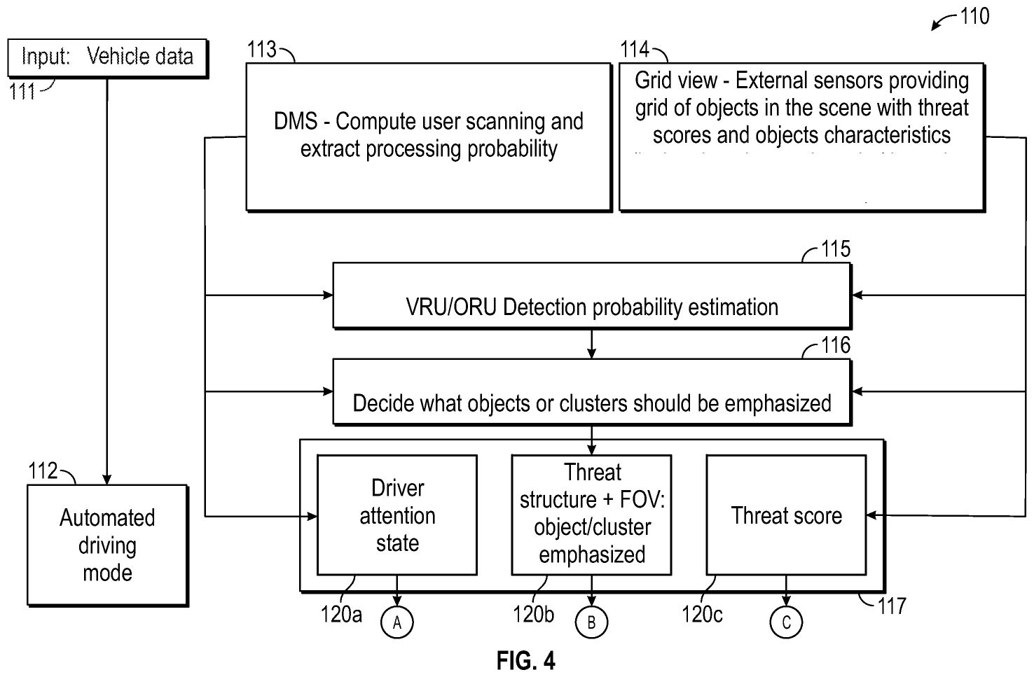

FIG. 4 depicts an embodiment of a method 110 for determining a driving scenario. The method 110 may be part of the method 80 described in conjunction with block 83.

At block 111, the processing device receives vehicle data indicative of vehicle conditions, including vehicle dynamics and operating mode. For example, the operating mode is an automated or autonomous driving mode (block 112). The operating mode may also be a manual driving mode. The autonomous driving mode may be a fully autonomous mode, or a partially autonomous mode such as driver assist mode, adaptive cruise and lane-keeping assist, parking assist and others (e.g., modes in which a user does not control speed and/or steering at certain times or under certain conditions). The autonomous mode may include various levels of automation in semi-autonomous drive (e.g., level 2 and 3 automation levels).

At block 113, user detection data is acquired, and is used to assess the level of user attentiveness (i.e., is the user attentive or inattentive). For example, a DMS camera can monitor the driver for indications of stress (e.g., facial color and expression), and track eye gazing to determine where the driver is looking. The determination of attentiveness can include a confidence level.

At block 114, environment data is acquired from external sensors, such as cameras and/or radar assemblies. In one embodiment, the environment data is processed to provide a grid view of detected objects in the environment, and may provide threat scores (e.g., based on object location, speed and/or trajectory). The grid view may include or be associated with object characteristics (e.g., isolated or clustered, static/dynamic, inside or outside FOV).

At block 115, the processing device estimates a detection probability, to determine a probability of whether the user is looking at a given location in the grid. The detection probability can be calculated for any desired location, pixel, grid region and/or detected object.

For example, objects (potential threats) are identified in the grid, and the grid is presented to the user. Eye scanning information is used to estimate a duration at which the user's gaze is focused on locations associated with each object. The duration is used to derive a probability value (e.g., fraction or percentage) for each object.

The grid is processed to generate a matrix of pixels, where each pixel is a region of the grid and is associated with a threat score. A threat score of zero may be populated for those pixels in which no object is location and/or no object trajectory is expected to intersect the pixels. Multiplying the detection probability by the threat score for each pixel results in a “detection probability” value. The detection probability value may be calculated as the average (or maximum) detection probability of all the pixels associated with a given object.

At block 116, the processing device determines whether any objects or object clusters are to be emphasized in the notification. For example, objects located in the path of the vehicle (and those with a trajectory predicted to intersect with the vehicle path) and/or objects in which the detection probability is low (below a threshold value) are selected for greater emphasis.

At block 117, the processing device outputs or maintains data that is used to design the notification. Examples include a driver attention state 120a, a threat structure and indications 120b of which object(s) should be emphasized, and a threat score or threat level 120c.

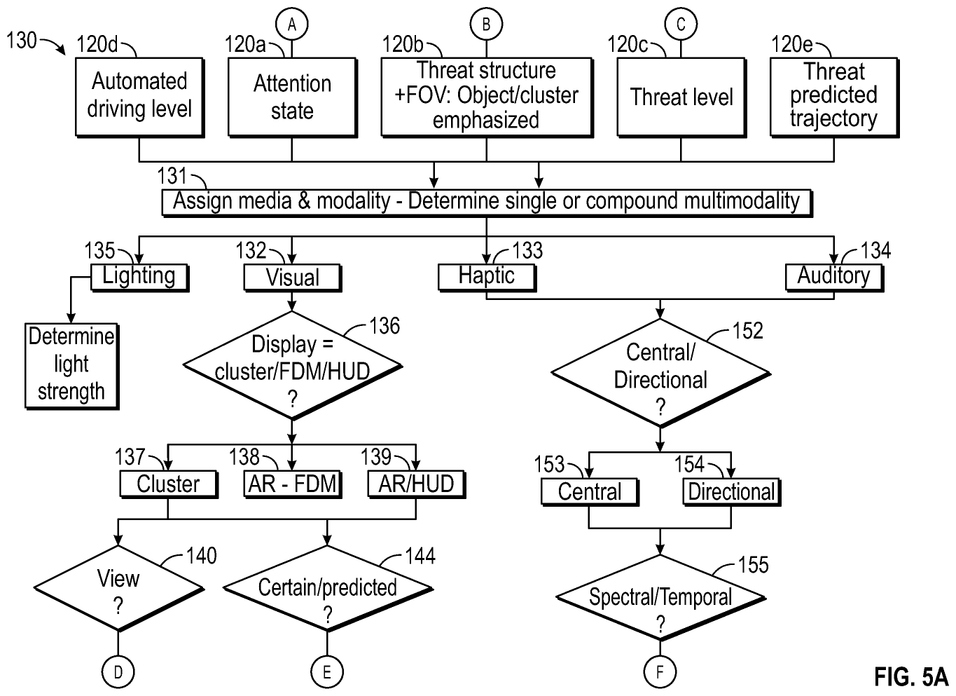

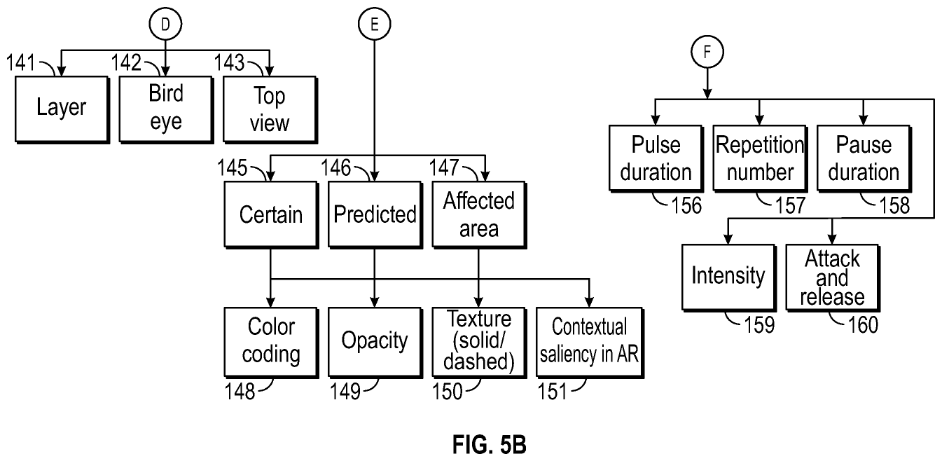

The driver attention state 120a, threat structure and indications 120b and threat score or threat level 120c are provided. Although not shown in FIG. 4, an indication of vehicle control state (automated driving level) 120d and a predicted threat trajectory (of one or multiple objects) 102e are provided. It is noted that the driver attention state 120a, the threat structure and indications 120b, and the threat score 120c may be applied as inputs to the method depicted by FIGS. 5A and 5B (as represented by elements “A”, “B” and “C”).

Based on these inputs, a user notification can be displayed, which enhances user awareness of a situation. The user notification provides a visual and/or graphical display that notifies the user of potential threats and their predicted trajectories. The user notification provides information including the predicted trajectory of objects identified as threats and/or a prediction as to whether object trajectory will intersect with the ego vehicle trajectory, and may also include indications that are customized to threat level and/or user attentiveness. Other information includes threat scores, confidence scores, likelihood of intersection, etc.

FIGS. 5A and 5B depict an embodiment of a method 130 of selecting modalities and attributes of a notification. The method 130 includes steps or stages represented by blocks 131-160. The various modalities and attributes are provided for illustrative purposes and are not intended to be limiting, as fewer than all of the modalities and attributes may be employed in designing a notification. It is noted that the method 130 begins at FIG. 5A and continues at FIG. 5B. As shown, block 140 connects to blocks 141-143 (as represented by element “D”), block 144 connects to blocks 145-147 (as represented by element “E”), and block 155 connects to blocks 156-158 (as represented by element “F”),

At block 131, input data is provided. For example, the outputs 120a-c are provided, as well as operating mode 120d and the predicted trajectory 120e of one or more objects identified as threats. Based on this, a notification is generated by selecting appropriate modalities and their characteristics.

In this example, the processing device can select visual/graphical modalities (block 132), haptic modalities such as vibration (block 133), auditory modalities such as beeps, voice alerts and others (block 134) and/or lighting modalities (block 135).

Visual modalities include any representation that is visible to the user, and may be textual, alphanumeric, graphical, symbolic and/or any other type of visual indication. Visual modalities may also be selected based on the available visual display types. At block 136, the processing device determines the available types of display. For example, the processing device can select a cluster display (e.g., digital instrument panel) at block 137, select an augmented reality FDM at block 138, select an augmented reality HUD at block 139, or select a combination thereof

The processing device, at block 140, may determine whether multiple views are available. If available, the processing device can choose from one or more of a layer view (block 141), a bird's eye view (block 142) and a top view (block 143).

At block 144, the system customizes the visual display based on factors such as confidence level P (probability of misdetection), threat level based on prediction, and affected areas of the environment and corresponding locations in the visual display. For example, the system determines the confidence level at block 145, the threat level at block 146 and the affected area at block 147.

The processing device customizes the visual display, for example, by adding or incorporating visual indicators that emphasize the threat or potential threat and corresponding predicted trajectory or trajectories. The visual display can be colored coded by threat level (e.g., red for high threat, yellow for medium threat, etc.) at block 148, and visual representations of objects can be given an opacity based on threat level at block 149. In addition, the texture of a representation (e.g., a trajectory line, an outline around an object) can be selected to indicate threat level and/or confidence (block 150).

In augmented reality displays, at block 151, visual indicators can be added or emphasized based on contextual saliency. A contextual salient visual indicator or feature is a feature manipulated based on context, such as threat level and user attentiveness. For example, features of visual components (e.g., detected objects and trajectories) can be gradually changed (e.g., transition between colors, gradual brightening, blink rate, transparency) as the threat level increases or decreases.

Auditory and/or haptic notifications can also be selected or customized based on threat level, attentiveness and other factors. For example, the processing device at block 152 determines whether directional indicators should be used, and selects from a central (non-directional) indicator at block 153 and a directional indicator at block 154. Directionality can be used to prompt the user to direct attention to a specified location of a threat or potential threat.

At block 155, the processing device can customize the auditory and/or haptic indicators, for example, by adjusting temporal and/or spectral properties thereof. For example, auditory or haptic pulse duration (block 156), number of pulse repetitions (block 157) and pause duration (block 158) can be selected. In addition, the intensity of sound or haptic signals can be adjusted based on threat level and/or attentiveness, at block 159. Attack and release (the rate of increase and decrease of intensity of a sound or haptic signal) can also be adjusted at block 160.

In an embodiment, visual content serves as a baseline modality. Additional modalities can be added to a notification based on threat level and attentiveness. For example, haptics and sound are added as additional layer(s) to draw attention when needed. Deciding on the selected modality or modalities is a function of, for example, driving automation level, the urgency of the situation and the attentional state of the user. For example, in high urgency situations, all three modalities are used. In medium urgency situations, visual and haptics are employed when the user is attentive, and sound is added when inattentive. In low urgency situations, the display may be visual only when the driver is attentive, with mild haptics added when the user is inattentive.

Dual combinations of modalities may be determined if fewer than all of the modalities are available. For example, if haptics are not available, visual and sound modalities are used in high urgency situations. In medium urgency situations, visual modalities are employed when the user is attentive, and sound with medium urgency characteristics is added when inattentive.

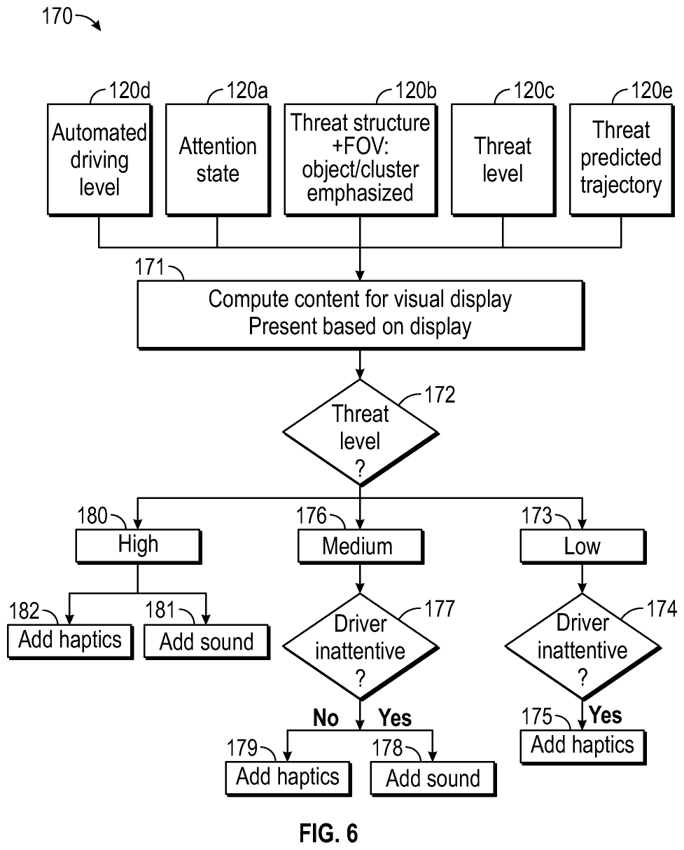

FIG. 6 illustrates a method 170 of allocating media for generation of a user notification. The method 170 includes steps or stages represented by blocks 171-182.

At block 171, input data is used to determine content for a visual display. The processing device determines the threat level at block 172, which in this example is categorized as low, medium or high.

If the threat level is low (block 173), the processing device determines whether the user or driver is attentive or inattentive at block 174. At block 175, if the user is inattentive, haptics can be added.

If the threat level is medium (block 176), the processing device determines whether the user is attentive or inattentive at block 177. If the driver is attentive, haptics are added at block 178. If the driver is inattentive, sound such as a notification beep can be added at block 179. If the threat level is high (block 180), then both sound (block 181) and haptics (block 182) can be added.

In one embodiment, the processing device monitors the threat level continuously and transitions from one level to the other by adjusting the visual and/or other modalities according to the method(s).

Interior lighting can be incorporated into the notification. For example, interior lighting can be strengthened in a sharp manner when a notification requires the operator to focus attention (or a passenger in an autonomous mode).

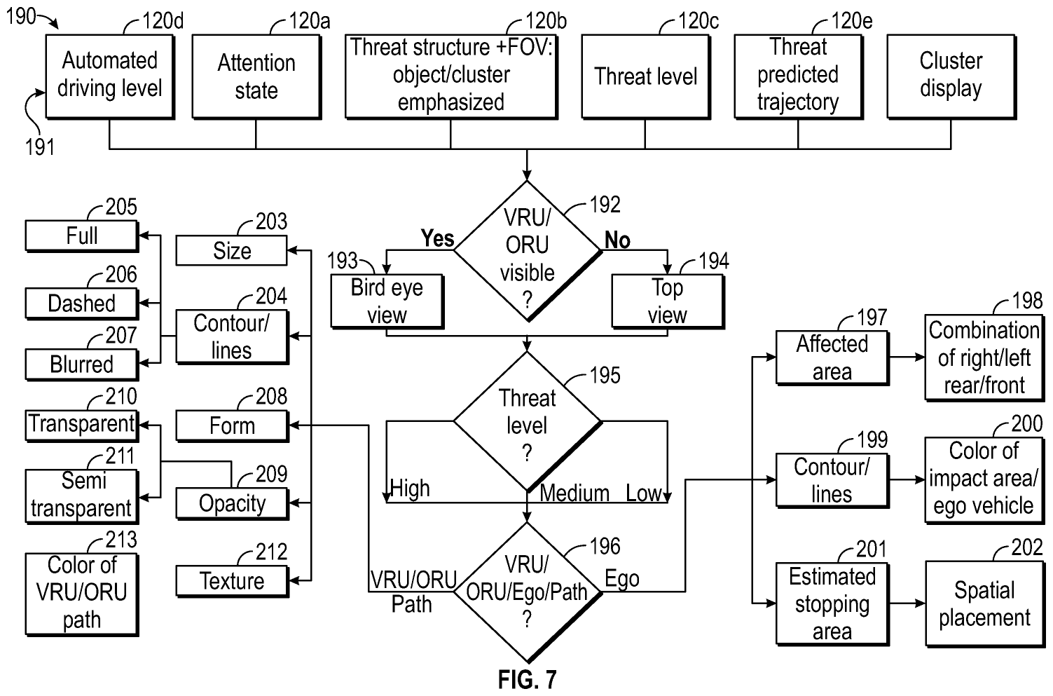

FIG. 7 depicts an example of a method 190 of customizing a user notification by providing various visual representations of threats and predicted trajectories associated with dynamic events. In this example, the vehicle display is a cluster display. The method 190 includes a number of steps or stages represented by blocks 191-213.

At block 191, the processing device receives input data, and if an object or object is detected as a threat, the system determines the appropriate view for use in a visual display (block 192). If the detected objects are visible, a bird's eye view may be selected (block 193). If an object or object is not visible to the user, a top view may be used. For example, if a detected object is in the back or side of the vehicle, or when a predicted impact is distant, the top view can be used to “zoom out” and provide full context of the scene (block 194). Tilting can be used to move between the two views.

At block 195, the threat level is determined, and at block 196, the detected and/or predicted trajectory of the detected object(s) and the ego vehicle are determined.

To represent detected objects and trajectories, visual content can be customized in various ways. Objects and/or trajectories are represented by visual elements whose attributes are selected based on threat level, threat structure, attentiveness and/or other factors. For example, object size can be selected (e.g., become slightly larger for greater threat) (block 203), and the shape of a visual element is selected (block 208) to indicate threat level. In addition, visual elements can be customized by opacity (block 209) and/or texture (block 212). The trajectory or path of a detected object and/or the ego vehicle can be given a color selected, for example, to indicate a threat severity (block 213).

For example, in a cluster display, certain objects can be distinguished from their predicted paths using different levels of opacity and textures. The opacity can be transparent (block 210), opaque or semi-transparent (block 211).

At block 204, contours and/or lines can be included to represent, for example, object and ego vehicle trajectories and potential impact or collision locations, and/or affected areas. Lines can be full or solid (block 205), dashed (block 206), blurred (block 207) or otherwise manipulated. For example, current object locations can be represented by a solid line, and predicted trajectories and intersections of predicted trajectories can have dashed lines or outlines. Shapes and/or lines can be blurred, objects and lines can be semi-transparent and/or a faint beam of light may be used. Other design methods are also possible as long as the distinction between the detected object and the predictions are presented in an intuitive manner.

In one embodiment, the display may be configured to represent and distinguish between validated and speculative threats or objects. “Validated” threats or objects are objects or conditions in an area that have been actually detected and interpreted by the processing device. “Speculative” threats or objects are those that are not directly detected, but are instead inferred by the processing device. A speculative threat can be distinguished in the display by assigning a different visual feature to the speculative threat than that assigned to a validated threat. For example, validated threats in the display field of view or at an edge of the display (if the validated threat is outside the field of view) can be represented by solid lines or opaque symbols or images, whereas speculative threats can be represented by dashed lines or semi-transparent symbols or images. Similar principles as those discussed above may apply when presentation involves augmented reality (e.g., windshield, FDM). In augmented reality displays, it is desirable to leave the visual scene clear and easy to process. Contextual saliency principles for a particular scene or object can be applied to draw attention to visible targets while avoiding attentional capture (e.g., use changes of brightness, contrast emphasis, color modifications, blinking, and other modifications).

For augmented reality (AR) displays, in one embodiment, the following rules are applied: predicted trajectories are limited to the vicinity of detected objects, using a subtle or unobtrusive visual indicator such as an outline or subtle glow that will not visually obscure the scene. Visualization in augmented reality displays can be compatible with corresponding indicators in a cluster display (or other non-AR display) for medium and high urgency alerts, forming a reference for detected object(s) in the real world. Predicted objects in the periphery of the AR display (soon to enter the scene) are reflected by a subtle directional flicker in the frame of the windshield, pinpointing the direction from which the target will appear.

Shape size and/or texture (or other manipulations) can be used to visualize predicted trajectories and provide contextual visualization. For example, a visual representation of a predicted path may be adjusted to reflect the confidence level of the computation. In addition, visualization of the predicted path can be adjusted (e.g., made thicker, brighter) to make the visualization stronger and less obscured as the ego vehicle approaches a detected object or predicted path of the detected object (e.g., time to collision (TTC) with the host vehicle).

Color coding may serve as a means to create a hierarchy in the urgency level of the situation. For example, objects and/or trajectories can be represented by the conventional color coding of red for urgent, orange for medium urgency and green (or the original object's color) for low urgency events. In one embodiment, the color and/or other attribute of a visual element is gradually changed to represent an increase in threat level and/or as the ego vehicle approaches. For example, the color can be changed “continuously” by gradually changing the color by shades between different color codes. Other visualizations than color can be used to indicate urgency, such as brightness, thickness, etc. A different visual hierarchy can be also applied in such strategies (e.g., manipulating brightness level, thickness values etc.).

Blocks 197-202 represent various ways that the ego vehicle can be represented in a visual display. The affected area or impact region of the ego vehicle (block 197) may be represented by color coding, brightening or otherwise emphasizing the areas of the ego vehicle (block 198) that would be affected by a collision with a detected object. Contours or lines (block 199) may be used with color to indicate the affected area or impact region, or otherwise to relate the detected object to a predicted location where collision is predicted to occur (block 200). The estimated stopping area (block 201) of the ego vehicle can be placed within the grid or area of a visual display (202).

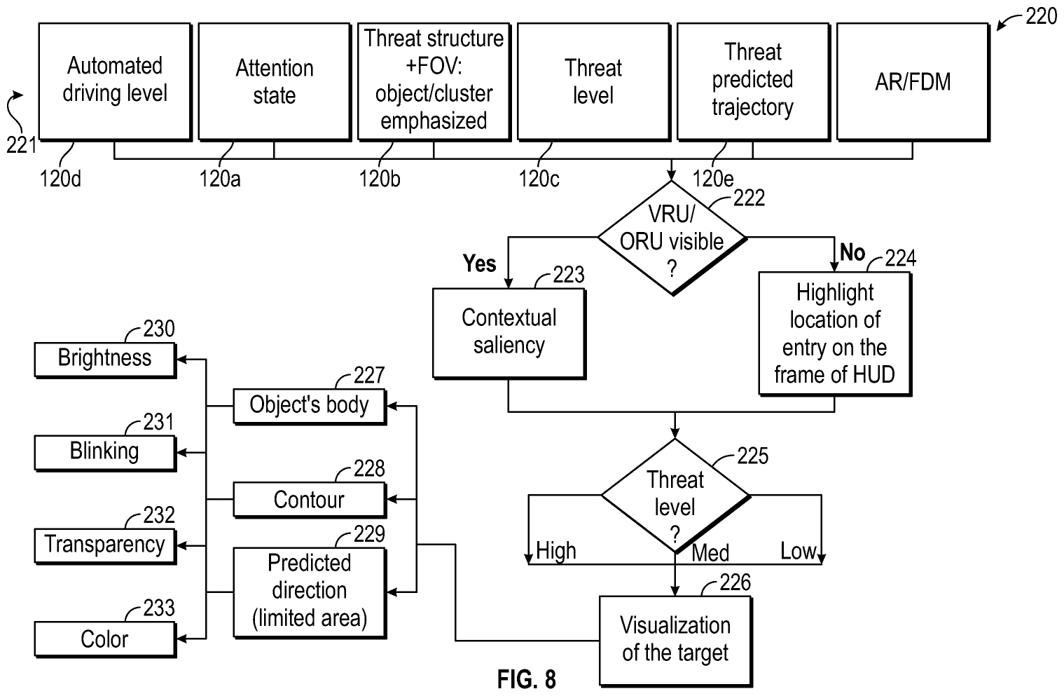

FIG. 8 depicts an example of a method 220 of customizing a user notification for an augmented reality HUD display. The method 220 includes a number of steps or stages represented by blocks 221-233.

At block 221, the processing device receives input data, and if an object or object is detected as a threat, the system determines whether the detected object is visible within the field of view of the display (block 222). If so, the object is represented according to contextual saliency principles discussed above (block 223). If the detected object is not visible, the object is represented on the HUD according to the predicted point of entry of the detected object into the field of view (block 224). At block 225, the threat level is determined, and at block 226, the detected object (target) is visualized by adding visual features in relation to the image of the detected object in the display. Visual features may be applied to the object's body (block 227), for example, by applying an outline and/or color to the body, or manipulating the transparency or brightness of the object. Other visualizations include contours or lines to indicate, for example, threat level (block 228), and visual features (e.g., lines, light beams, glowing regions) to indicate the predicted direction of the object (block 229). Examples of visual features that can be manipulated include brightness (block 230), blinking features with selected blink rates (block 231), transparency (block 232), and color (block 233).

Directional displays can be included to enhance situation awareness when a threat has a directional significance. For example, the affected area may be highlighted or emphasized as discussed above (e.g., the front, back, or sides of the ego vehicle representation are highlighted). Directional sound and haptics may be included in conjunction with the visual display to indicate direction.

For audible and/or haptic elements of a notification, pulsation spectral and temporal characteristics can be controlled to communicate the potential urgency of the situation. For example, in high urgency situations (e.g., high threat level), a high intensity pulse can be emitted with sharp attack and release of the stimuli envelope, and the stimuli includes short pulses with short inter-pulse intervals and a high number of repetitions. For medium urgency situations, auditory and/or haptic signals can be emitted via a medium intensity pulse with sharp attack and smoother release of the stimuli envelope, and the stimuli includes longer pulses with longer inter-pulse intervals and fewer repetitions. For low to medium urgency, the signals can be emitted as a low intensity pulse with medium attack and long release of the stimuli envelope, and the stimuli includes long pulses with long inter-pulse intervals and small number of repetitions to give the user a sense of low urgency.

When an object is far away, the urgency of a threat (and the confidence level of the prediction) is generally lower, and a visual notification only may suffice. For any of the modalities, the notification may be intensified when a user becomes inattentive.

The following is a description of examples of notifications generated under manual operation for various threat levels, and for instances where a driver is attentive or inattentive.

If the threat level is high, and the user is attentive, the notification is designed to express high urgency using visual, auditory and haptic modalities. The notification includes a visual display that highlights a detected (validated) object or objects, for example, by using red graphics to express urgency. In addition, the visual display distinguishes between detected objects that are inside the field of view, and their predicted path, and detected objects outside the field of view. Further, the visual display may distinguish between validated objects and speculative objects (e.g., by outlining validated objects with solid lines and speculative objects with dashed lines, or assigning different levels of transparency).

For example, if a detected object (a predicted target) is outside the field of view, a graphical indicator can be positioned at a periphery of the augmented reality display (or on another display such as a side mirror display, if available) along with predicted trajectory. The detected object representing a threat is also distinguished by the display from other objects in a scene that may not represent a threat in themselves. Validated and speculative objects outside of the field of view may be represented at the periphery using graphical indictors that distinguish speculative and validated objects.

Directional sound and haptics with urgent characteristics are included to optimize situation awareness (e.g., high intensity pulse with sharp attack and decay of the stimuli envelope, short pulses with short intervals and a high number of repetitions will give the user a high sense of urgency).

If the user is inattentive, a similar notification (i.e., similar to the notification for an attentive user) can be generated, but with an earlier escalation to higher urgency. In other words, the urgency of the threat (e.g., distance between the object and the ego vehicle) required to switch from a medium to a high threat level is lower for an inattentive driver than an attentive driver. Thus, the threat level will switch from medium to high earlier in time when the driver is inattentive.

If the threat level is medium and the user is attentive, the notification can express this level of urgency in the visual and haptic modalities. For example, a detected object is highlighted using orange graphics to express medium urgency. Directional haptics are included with medium urgency characteristics to optimize situation awareness (e.g., medium intensity pulse with sharp attack and smoother decay of the stimuli envelope, longer pulses with longer intervals and small number of repetitions will give the user a sense of medium urgency). If the user is inattentive, the notification can use the same visual and directional haptics as attentive, plus additional directional sound. An equivalent manipulation for inattentive users can be made by an increment of the spectral and temporal characteristics of haptic or sound if only one modality is added to the visual display. Sound characteristics may be matched to the haptic characteristics to form a synchronized output. Furthermore, the threat level will switch from low to medium earlier in time when the driver is inattentive.

If the threat level is low and the user is attentive, the notification includes visual modalities without additional modalities. The notification in this instance is designed to express low urgency in the visual channel. For example, use green graphics (or simply the original object's color) to express low urgency. If the user is inattentive, the notification includes similar visual modalities, plus mild directional haptics if needed to draw attention. Escalation (switch from low to medium or medium to high) may be performed across all modalities if the user is inattentive. The haptics are applied with low urgency characteristics (e.g., low intensity pulse with medium attack and long decay of the stimuli envelope, long pulses with longer intervals and very few repetitions will give the user a sense of low urgency).

In a fully autonomous mode (e.g., for an autonomous vehicle), for any given threat level, the notification is similar to that discussed above for manual control, to provide better situation awareness for the passengers. Escalation between medium and high threat level notification can be manifested by changes of the spectral and temporal aspects of the modalities as threat level increases (e.g., as time to collision decreases). If the user is inattentive, the escalation is manifested in all modalities, and may be escalated earlier than if the user is attentive. Also, interior lighting may be manipulated to draw the user's attention back to the scene. Lighting can remain dimmed for low threat scores. In a semi-autonomous vehicle in a partially autonomous mode, when user control is disengaged, and the partially autonomous mode is active, the notification may be similar to the fully autonomous vehicle notification. An explanatory layer can be added in both autonomous modes if time permits for appropriate processing.

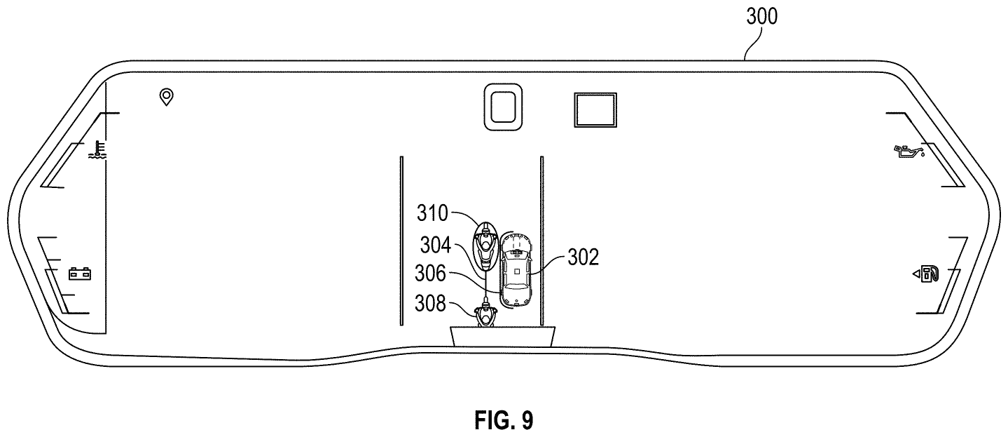

FIGS. 9-11 show examples of a cluster display including visual representations configured as discussed above. In these examples, the operating mode is manual, and the driver is attentive.

Referring to FIG. 9, an example of a cluster display 300 is shown for a situation in which a detected object is outside of the FOV, the threat structure is discrete (a single threat), and the threat level is high. In this example, a motorcycle is detected that is approaching the vehicle from behind and on the left to pass. The display combines an ego vehicle image 302, a trajectory 304 of the motorcycle, and a potential impact graphic 306 showing areas of the vehicle that could be affected by a collision. The current position of the motorcycle is shown by a red image 308, and the predicted position of the motorcycle is shown by a motorcycle graphic 310. The display 300 can represent the motorcycle in other ways, for example, by highlighting the predicted path of the motorcycle using a beam of light, dashed line, etc.

As the motorcycle is detected outside of the field of view (assuming that it cannot be viewed in a bird's eye view), the display is configured as a top view to provide context to the user. The motorcycle in its current location is marked in solid red. The affected area (the impact graphic 306) is also marked in a solid red curved line. Predicted path and predicated location is marked in a dashed red line

In this example, visual attention is directed to a focused area on the screen, avoiding any red icon elsewhere, and no explanatory layer is included to avoid attracting attention elsewhere in manual driving. A directional sound and haptics (rear left) can be added to make the attentive user understand the directionality of the threat and look at the cluster when urgency is high.

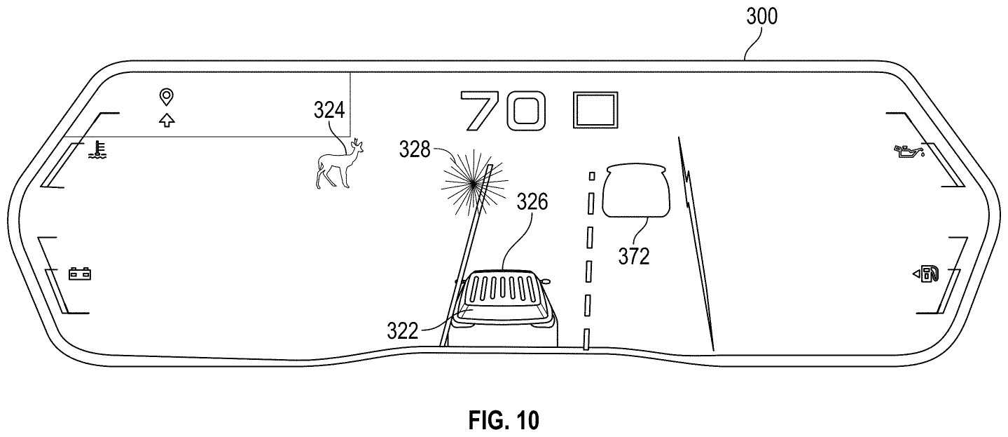

Referring to FIG. 10, another example of a cluster display 300 is shown for a situation in which the detected object is outside of the FOV, the threat structure is discrete (a single threat), and the threat level is medium. In this example, a deer is detected that is predicted to intersect with the vehicle. The display combines an ego vehicle image 322, an image 324 of the deer, and may also include dashed lines to indicate trajectory. A potential impact graphic 326 shows areas of the vehicle that could be affected by a collision.

The image 324 of the deer in its current location is marked in a semi-transparent orange. The affected area is also marked in a graphic 328 including a dashed orange line with a subtle glow. Visual attention is directed to a focused area on the display 320, avoiding any orange icon elsewhere, and no explanatory layer is provided in manual driving. A directional haptic pulse (front left) may be emitted to make the attentive user understand the directionality of the threat and look at the cluster when urgency is medium. In this example, the deer has been actually detected, and is thus considered certain. If one or more objects or threats are speculative, they can be distinguished from the deer, for example, using dashed outlines.

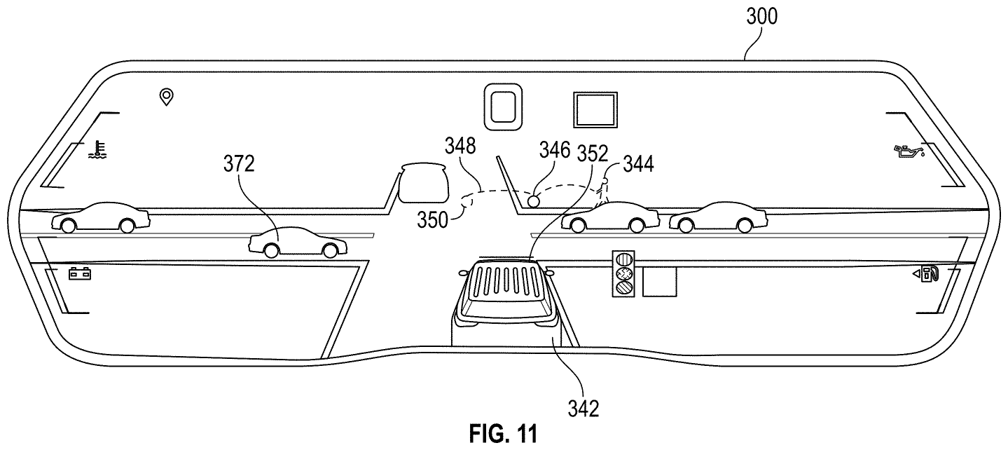

Referring to FIG. 11, an example of a cluster display 300 is shown for a situation in which detected objects are inside of the FOV, the threat structure is combined (multiple threats), and the threat level is high. In this example, a pedestrian and a ball are approaching a roadway near an intersection. The display combines an ego vehicle image 342, a pedestrian image 344, a current image 346 of the ball, a predicted trajectory 348, and a graphic 350 of the ball in a predicted location. A potential impact graphic 352 shows areas of the vehicle that could be affected by a collision.

The ball in its current location and the affected car area are marked in a solid red curved line. The predicted path, location and pedestrian (child) running after the ball are marked in a dashed red line, and no explanatory layer is included. A directional sound and haptics (front pedestrian brake alert, FPB) will make the user detect the directionality of the threat, glimpse at the cluster and then straight ahead to the scene.

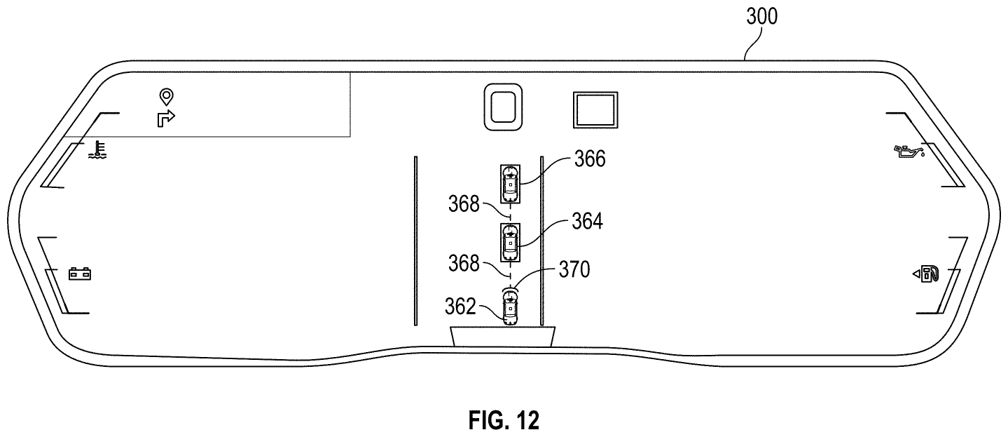

The example of FIG. 11 also illustrates an example of a representation of a validated threat or object, in combination with a representation of a speculative threat. In this example, the ball is certain, in that the ball was actually detected by a threat detection system in the ego vehicle. The pedestrian is speculative, in that the system infers from the context of the situation that there may be a child following the ball. Thus, the image 346 of the ball includes a solid outline (circle) and the pedestrian image 344 includes a dashed line. Referring to FIG. 12, an example of a cluster display 300 is shown for a combined threat structure having a medium to low threat level. In this example, the display includes an ego vehicle image 362, and vehicle images 364 and 366 representing vehicles ahead of the ego vehicle. In this situation, a vehicle brakes ahead of the ego vehicle, causing the vehicles represented by objects 364 and 366 to brake. The display is a top view to support presenting content in from of the ego vehicle that may not be visible to the user.

In this example, the vehicle images 364 and 366 are presented with an orange glow, and dashed orange lines 368 represent the predicted stop effect. An orange line 370 marks the predicted impact area. A directional haptics signal may be emitted to make the attentive user determine the directionality of the threat and look at the cluster display.

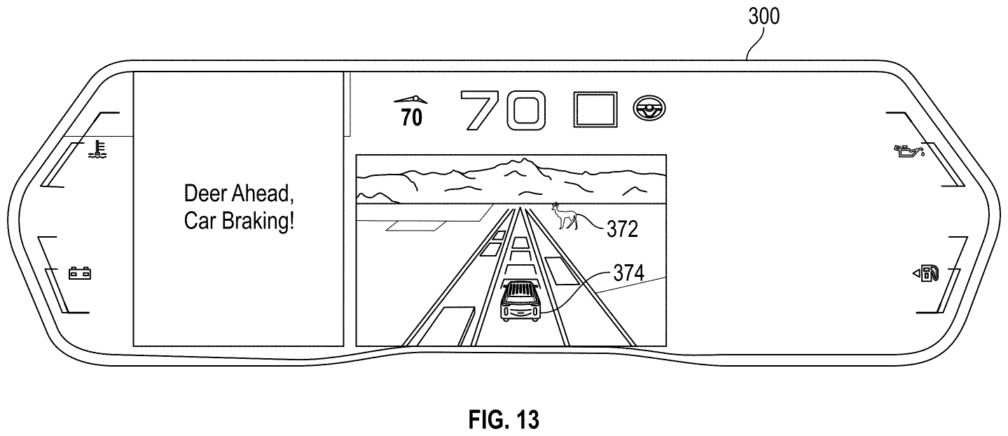

FIG. 13 shows an example of a cluster display 300 for a vehicle operating in an autonomous mode (for a fully autonomous or semi-autonomous vehicle). In this example, the threat structure is single and the threat level is high. The detected object is a deer represented by a deer image 372, and the ego vehicle is represented by an ego vehicle object 374. As shown, explanatory text (“Deer Ahead, Car Braking”) is provided to ensure that the user grasps the full context of the scene.

In the above, the notifications are designed to direct the user's attention to specific areas of the display. Other objects not considered a threat may be represented in a subdued or more subtle manner than the objects considered a threat. For example, other vehicles in the above displays are represented by gray graphical objects.

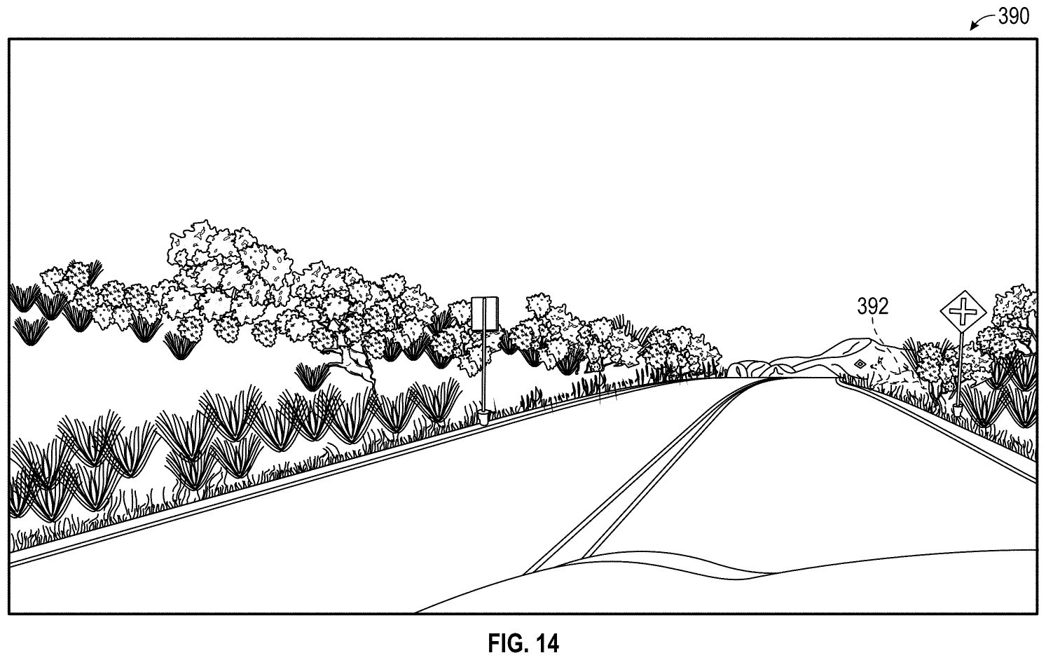

FIG. 14 shows an example of an augmented reality (AR) display, such as a HUD 390. In this example, graphical objects and features are kept to a minimum needed to alert the user. A visual layer, such as a temporary highlight 392 is overlaid onto the deer in the HUD 390. A visual layer is added to the HUD 390 to provide better situation awareness. Temporary highlighting of objects that may be missed, compatible with the visualization in the cluster, can be used to provide reference to the threat in the real world. Directional sound and haptics can be included to alert the user. In this example, the deer is considered certain; any speculative objects or threats can be represented, for example, at a periphery of the HUD 390, in a manner that is distinguishable from the deer (or other certain objects or threats).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

1. A system for notifying a user of a vehicle, comprising:
a receiving module configured to receive detection data from one or more sensors;
a threat analysis module configured to receive object detection data related to a detected object in an environment around the vehicle, acquire a predicted trajectory of the detected object, and determine whether the detected object constitutes a threat based on the predicted trajectory of the detected object and a vehicle trajectory;
a user condition module configured to receive user monitoring information and determine a user attentiveness; and
a threat display module configured to, based on determining that the detected object constitutes a threat:
determine an operating scenario based on-a the user attentiveness, a field of view, an operating mode, and a threat level; and
generate a notification to the user representing the threat, the notification including a visual representation of the detected object and a visual indicator of the predicted trajectory of the detected object, wherein at least one of the visual representation and the visual indicator is customized based on the operating scenario and based on the user attentiveness.

2. The system of claim 1, wherein the operating mode is selected from a manual operating mode, a partially autonomous operating mode and a fully autonomous operating mode.

3. The system of claim 1, wherein the operating scenario includes a threat structure selected from a discrete threat and a combined threat.

4. The system of claim 3, wherein the notification includes a visual representation of a dependency between multiple objects representing the combined threat.

5. The system of claim 1, wherein the threat display module is configured to incorporate at least one of an auditory alert and a haptic alert into the notification based on at least one of:
determining that a threat level is above a selected value; and
determining that the user is inattentive relative to the detected object.

6. The system of claim 5, wherein a property of at least one of the visual representation of the detected object, the visual indicator of the predicted trajectory, the auditory alert and the haptic alert is altered in real time as the threat level changes.

7. The system of claim 6, wherein the property of at least one of the visual representation and the visual indicator is selected from at least one of a color, an opacity, a brightness, a blink rate, a texture and an intensity.

8. The system of claim 1, wherein the notification includes an adjustment of interior lighting in the vehicle based on at least one of the threat levels and the user attentiveness.

9. A method of notifying a user of a vehicle, comprising:
receiving detection data from one or more sensors;
receiving user monitoring information and determining a user attentiveness;
receiving object detection data related to a detected object in an environment around the vehicle based on the detection data, acquiring a predicted trajectory of the detected object, and determining whether the detected object constitutes a threat based on the predicted trajectory of the detected object and a vehicle trajectory;
based on determining that the detected object constitutes a threat, determining an operating scenario based on-a the user attentiveness, a field of view, an operating mode, and a threat level; and
generating a notification to the user representing the threat, the notification including a visual representation of the detected object and a visual indicator of the predicted trajectory of the detected object, wherein at least one of the visual representation and the visual indicator is customized based on the operating scenario and based on the user attentiveness.

10. The method of claim 9, wherein the operating mode is selected from a manual operating mode, a partially autonomous operating mode and a fully autonomous operating mode.

11. The method of claim 9, wherein the operating scenario includes a threat structure selected from a discrete threat and a combined threat.

12. The method of claim 11, wherein the notification includes a visual representation of a dependency between multiple objects representing the combined threat.

13. The method of claim 9, wherein a threat display module is configured to incorporate at least one of an auditory alert and a haptic alert into the notification based on at least one of:
determining that a threat level is above a selected value; and
determining that the user is inattentive relative to the detected object.

14. The method of claim 13, wherein a property of at least one of the visual representation of the detected object, the visual indicator of the predicted trajectory, the auditory alert and the haptic alert is altered in real time as the threat level changes.

15. The method of claim 14, wherein the property of at least one of the visual representation and the visual indicator is selected from at least one of a color, an opacity, a brightness, a blink rate, a texture and an intensity.

16. The method of claim 9, wherein the notification includes an adjustment of interior lighting in the vehicle based on at least one of the threat level and the user attentiveness.

17. A vehicle system comprising:
a non-transitory memory having computer readable instructions; and
a processing device for executing the computer readable instructions, the computer readable instructions controlling the processing device to perform:
receiving detection data from one or more sensors;
receiving user monitoring information and determining a user attentiveness;
receiving object detection data related to a detected object in an environment around the vehicle based on the detection data, acquiring a predicted trajectory of the detected object, and determining whether the detected object constitutes a threat based on the predicted trajectory of the detected object and a vehicle trajectory;
based on determining that the detected object constitutes a threat, determining an operating scenario based on-a the user attentiveness, a field of view, an operating mode, and a threat level; and
generating a notification representing the threat to a user of the vehicle, the notification including a visual representation of the detected object and a visual indicator of the predicted trajectory of the detected object, wherein at least one of the visual representation and the visual indicator is customized based on the operating scenario and based on the user attentiveness.

18. The vehicle system of claim 17, wherein a threat display module is configured to incorporate at least one of an auditory alert and a haptic alert into the notification based on at least one of:
determining that a threat level is above a selected value; and
determining that the user is inattentive relative to the detected object.

19. The vehicle system of claim 18, wherein a property of at least one of the visual representation of the detected object, the visual indicator of the predicted trajectory, the auditory alert and the haptic alert is altered in real time as the threat level changes.

20. The vehicle system of claim 17, wherein the notification includes an adjustment of interior lighting in the vehicle based on at least one of the threat level and the user attentiveness.
